(19) United States
(12) Patent Application Publication
(10) Pub. No.: US 2024/0166461 A1
(43) Pub. Date: May 23, 2024

(54) METHOD FOR PRODUCING AN ELECTRODE STACK, AND STACKING DEVICE

(71) Applicant: GIESECKE+DEVRIENT CURRENCY TECHNOLOGY GMBH, Munchen (DE)

(72) Inventors: Xaver THUM, Wolfratshausen (DE); Markus SPERL, Straubing (DE)

(21) Appl. No.: 18/552,112

(22) PCT Filed: Mar. 17, 2022
(86) PCT No.: PCT/EP2022/025108

§ 371 Date: Sep. 22, 2023

(30) Foreign Application Priority Data
Mar. 24, 2021 (DE) 10 2021 001 544.4

(51) Int. Cl. B65H 29/40; B65H 31/34; H01M 10/04

(52) U.S. Cl. CPC B65H 29/40; B65H 31/34; H01M 10/0404; B65H 2301/4223; B65H 2801/72

(57) ABSTRACT

A method is provided for producing an electrode stack with flat electrode elements, including: a) providing a first electrode element; b) inserting the first electrode element into an intermediate space formed by stacking fingers of a stacking wheel which rotates about a rotation axis; c) transporting the first electrode element with the stacking wheel; d) removing the first electrode element from the intermediate space; e) arranging the first electrode element in a stacking position; f) providing a second electrode element; g) inserting the second electrode element into a further intermediate space different from the intermediate space and formed by stacking fingers of the stacking wheel; h) removing the second electrode element from the further intermediate space; and i) arranging the second electrode element in the stacking position and producing the electrode stack. The first electrode element is moved to a lateral target position by a movable alignment element.

The invention relates to a method for producing an electrode stack with flat electrode elements. At least one first electrode element and one second electrode element are provided. The electrode elements are inserted into a respective intermediate space which is in each case formed by stacking fingers of at least one stacking wheel which rotates about a rotation axis. Furthermore, the electrode elements are transported with the stacking wheel and removed from the respective intermediate space. The electrode elements are arranged in a stacking position, and the electrode stack is produced. The invention also relates to a corresponding stacking device.

The stacking of flat electrode elements is known. Thus, electrode elements are usually stacked for producing electrochemical energy stores, such as lithium-ion batteries, or energy converters, such as fuel cells. In particular, in the production of pouch cells, a widely used design of a lithium-ion rechargeable battery, electrode elements are stacked.

The electrode elements in this case are usually designed as a cathode, based, for example, on aluminum foil, and/or as an anode, based, for example, on copper foil. The smallest unit of each lithium-ion cell consists of two electrodes and a separator which separates the electrodes from one another. Later, after filling, the ion-conductive electrolyte is located in between.

During the stacking process, the electrode elements are stacked in a repeating cycle of anode, separator, cathode, separator and so on.

In addition to the other steps of producing electrochemical energy stores or fuel cells, such as the assembly or the contacting, the step of stacking often represents the bottleneck for the manufacturing throughput during production. Accelerating the stack is therefore of great interest.

Known methods for stacking the electrode elements rely on a gripper arm of a robot which grips and places the electrode element. However, according to previous knowledge, a significant increase in speed is no longer to be expected here.

Further known methods rely on a rotating stacking wheel, with which the electrode elements are deposited onto an electrode stack, for the stack formation.

In this respect, WO 2020/212316 A1 describes a method for producing an electrode stack of anodes and cathodes for a lithium-ion battery of an electrically driven motor vehicle, in which the anodes and the cathodes are conveyed in receptacles of a rotationally driven or rotationally drivable stacking wheel, and the anodes and cathodes received in the receptacles are conveyed to a stacking compartment by means of a rotation of the stacking wheel.

It is an object of the invention to create a method or a stacking device with which or in which an electrode stack with flat electrode elements is produced more accurately.

This object is achieved according to the invention by a method and a stacking device with the features according to the respective independent claims. Advantageous embodiments of the invention are the subject matter of the dependent claims.

In a method according to the invention, an electrode stack with flat electrode elements, in particular of an electrochemical energy store or an energy converter, is produced. The following steps are carried out:
a) providing a first electrode element;
b) inserting the first electrode element into an intermediate space which is formed by stacking fingers, in particular between stacking fingers, of at least one stacking wheel which rotates about a rotation axis;
c) transporting the first electrode element with the stacking wheel;
d) removing the first electrode element from the intermediate space;
e) arranging the first electrode element in a stacking position;
f) providing a second electrode element;
g) inserting the second electrode element into a further intermediate space which is different from the intermediate space and is formed by stacking fingers, in particular between stacking fingers, of the stacking wheel;
h) removing the second electrode element from the further intermediate space; and
i) arranging the second electrode element in the stacking position and producing the electrode stack.

As an important idea of the invention, it is provided that at least the first electrode element and/or the second electrode element is moved to a lateral target position by at least one movable alignment element, in particular an alignment element external to the stacking wheel, in particular an actively movable alignment element.

The invention is based on the knowledge that the stacking accuracy can be increased by the movable alignment element. By means of the movable alignment element, the electrode elements can be aligned more accurately in the lateral direction, i.e., in particular in the axial direction with respect to the rotation axis of the stacking wheel. As a result of the more accurate stack formation, an electrochemical energy store or an energy converter can be more powerful.

In known stacking devices for producing an electrode stack, only one immovable side wall is known, which performs the lateral alignment. As a result of the immovable side wall, however, the electrode elements can only be aligned with a lower accuracy.

The lateral target position can be designed as an absolute target position in which the lateral alignment of the electrode elements is carried out with respect to a reference point on the stacking device or external to the stacking device. Alternatively, the lateral target position may however also be designed as a relative target position, in the case of which the electrode elements themselves are the reference for aligning the electrode elements. In particular, in the case of the relative target position, it is only provided that no electrode elements protrude laterally too far from the electrode stack in the produced electrode stack.

The alignment element can be movably fastened to the stacking device by at least one bearing, in particular a two-way bearing.

However, the alignment element may also be formed without bearings.

In the case of the configuration without bearings, the alignment element is preferably slightly flexible so that, even though the alignment element is fixedly connected to a stacking device at at least one point, it can be set in rotation or in vibration, i.e., in particular a high-frequency back-and-forth movement in the axial direction. The electrode elements can then be brought to the lateral target position by the axial movement of the alignment element.

In the lateral target position, the electrode elements are stacked on top of one another, in particular in a flush and congruent manner. As a result, an accurate electrode stack is formed and the performance of the energy store or of the energy converter is increased.

In particular, it is provided that the alignment of the electrode elements is carried out with an accuracy of at least +/−0.2 mm, preferably at least +/−0.1 mm, i.e., the deviation from the lateral target position is to be in particular at most 0.2 mm, preferably at most 0.1 mm.

In particular, the alignment element is coupled to an actuator which actively moves the alignment element.

The alignment element may, for example, be formed by a metal, in particular an aluminum alloy.

In particular, the first electrode element is designed as a cathode and the second electrode element as an anode. In particular, a separator or a separating layer is arranged between the first electrode element and the second electrode element. This structure is preferably repeated as described above.

Alternatively, the electrode elements can also already be formed as a prefabricated cell which comprises a cathode, an anode and at least one separating layer. Then, the first electrode element can be a first cell, and the second electrode element can be a second cell.

The stacking accuracy, which is achieved by the movable alignment element, may, for example, be detected by the use of camera systems of the stacking device.

It is preferably provided that the alignment element moves the second electrode element simultaneously with the first electrode element to the lateral target position. The alignment element can thus align at least two electrode elements simultaneously. As a result, the alignment can be carried out more quickly and the electrode stack can be produced more quickly.

In a further preferred embodiment, at least three electrode elements are simultaneously aligned by the alignment element.

Furthermore, it is preferably provided that at least the first electrode element, in particular and/or the second electrode element, is pressed to the lateral target position by the alignment element at an edge of the first electrode element extending radially to the rotation axis. In particular, the edge extending radially to the rotation axis is the short edge of the electrode element. By pressing the first electrode element at the short edge, the electrode element can be gently moved to the the target position.

Furthermore, it is preferably provided that the movement of at least the first electrode element, in particular and/or of the second electrode element, to the lateral target position is carried out while the first electrode element is transported in the intermediate space. This is advantageous since the alignment is already carried out before the respective electrode element is placed onto the electrode stack. As a consequence, it is no longer necessary to subsequently process the electrode elements on the stack or the stack by pushing the respective electrode elements of the stack, for example with sliders, and thereby aligning them.

Furthermore, it is preferably provided that at least the first electrode element is additionally moved, in particular pressed, to the lateral target position by means of a further movable alignment element, which is in particular external to the stacking wheel, wherein the further alignment element acts against a direction of action of the alignment element. As a result, the lateral target position can be reached even more accurately. In particular, it is provided that the the alignment element moves the respective electrode element from a first side toward the center and the further alignment element moves the respective electrode element toward the center from a second side opposite the first side. The further alignment element is advantageous since the respective electrode element can be pressed from two sides to the target position.

The further alignment element is, in particular, designed identically to the alignment element, except for the inverted sides.

Furthermore, it is preferably provided that the alignment element, and in particular the further alignment element, is moved axially to the rotation axis at a frequency between 0.5 Hz and 10 Hz. As a result of this movement, the respective electrode element is preferably contacted only once for alignment during the stay in the stacking wheel. This one-time contact is advantageous since the surface or the edge of the respective electrode element, in particular of the first electrode element and/or of the second electrode element, is preserved.

Furthermore, it is preferably provided that the alignment element, in particular and/or the further alignment element, vibrates axially to the rotation axis at a frequency of more than 20 Hz. By means of the vibration, the first electrode element and/or the second electrode element is moved gently to the lateral target position since the movement is carried out with little force. The low expenditure of force is possible since the respective electrode element is contacted several times with the vibrating alignment element. With each contact, the electrode element can be moved a little bit in the direction of the target position.

Furthermore, it is preferably provided that the alignment element is moved by an unbalance drive unit. The unbalance drive unit is in particular designed as an unbalance motor. The unbalance motor is a rotary machine, to the shaft of which adjustable weights are attached, which produce circular mechanical vibrations during operation due to the occurring centrifugal forces. The frequency of the vibration of the unbalance motor is in particular determined by the motor rotation speed. With increasing frequency, the output vibration power increases. If the same mechanical vibration power as in the case of a fast running motor is to achieve with slow running motor, the weights are increased in mass and/or diameter. The frequency of the vibration of the alignment element can be specified by the rotation speed of the unbalance drive unit. The rotation speed is in turn preferably specified via the voltage of the unbalance drive unit.

Furthermore, it is preferably provided that at least first electrode element, in particular and/or the second electrode element, is contacted by the alignment element only in a partial region of the edge of the respective electrode element extending radially to the rotation axis. This is advantageous since the first electrode element and/or the second electrode element can thereby be moved more gently.

The invention also relates to a stacking device. The stacking device is designed to produce an electrode stack with flat electrode elements and comprises the following:
a provision unit which is designed to provide an electrode element;
at least one stacking wheel having a rotation axis and multiple stacking fingers arranged radially to the rotation axis, wherein the stacking fingers form multiple intermediate spaces which are each designed to receive at least one electrode element for transport; and
a stacking position which is designed for the arrangement of the electrode stack.

According to an important idea of the invention, it is provided that the stacking device has a movable alignment element, in particular an actively movable alignment element, which is designed to move the electrode elements or the first electrode element and/or the second electrode element to a lateral target position, in particular during transport by the stacking wheel.

The stacking wheel preferably has eight to thirty, in particular ten to twenty, stacking fingers.

The stacking fingers are in particular arranged distributed over the circumference of the stacking wheel.

It is preferably provided that the alignment element is arranged at a distance from the stacking wheel in the axial direction with respect to the rotation axis. Due to the axially spaced arrangement, the first electrode element and/or the second electrode element can be reliably moved by the alignment element even during fast rotation of the stacking wheel.

Furthermore, it is preferably provided that the alignment element is fastened only on one fastening side of the alignment element. In other words, the alignment element is preferably fastened to the stacking device only on one side. As a result of the one-sided fastening, the alignment element requires less maintenance and is more reliable.

Furthermore, it is preferably provided that the stacking device has a further movable alignment element, in particular a further, actively movable alignment element, which is arranged on the other side of the rotation axis with respect to a center of the rotation axis or which is arranged on the other side of the section axis with respect to a radial section axis of the stacking wheel. Preferably, the alignment elements are designed to be mirror-inverted. The alignment element and the further alignment element can move the first electrode element and/or the second electrode element more accurately to the lateral target position. By means of the additional further alignment element, the respective electrode element can now be pressed from two different sides. The further alignment element is preferably structurally identical to the alignment element, except for the formation with inverted sides.

Furthermore, it is preferably provided that the alignment element and/or the further alignment element has a curvature extending substantially in the direction of the rotation direction of the stacking wheel. In particular, the alignment element is curved in such a way that it is curved toward the center axis of the stacking wheel in the direction of the rotation direction. At the lower end of the alignment element, the distance from the center axis of the stacking wheel preferably corresponds to the lateral target position. As a result of the curvature, the respective electrode element can be moved further and further in the direction of the lateral target position with continuing rotation of the stacking wheel. In the event that the stacking device has a further alignment element, the alignment element and the further alignment element preferably form a two-walled half-funnel, wherein the two walls formed by the alignment elements are formed in particular opposite one another so that the respective electrode elements can be contacted on two opposite sides in order to be moved to the lateral target position.

Furthermore, it is preferably provided that the stacking device has an additional movable alignment element which is arranged after the alignment element with respect to a rotation direction of the stacking wheel. The additional alignment element preferably contacts the electrode element for aligning on the same side as the alignment element, but only later in time. Thus, the additional alignment element can, for example, perform the fine alignment work while the alignment element performs the rough alignment work. For example, the additional alignment element can be operated with a smaller amplitude than the alignment element.

Furthermore, it is preferably provided that the stacking device has a carried-along stacking bottom for receiving the electrode stack.

The preferred embodiments presented with reference to the method according to the invention and their advantages apply accordingly to the stacking device according to the invention and vice versa.

Further features of the invention result from the claims, the figures and the description of the figures.

Exemplary embodiments of the invention are explained in more detail below with reference to a schematic drawing.

In the Figures:

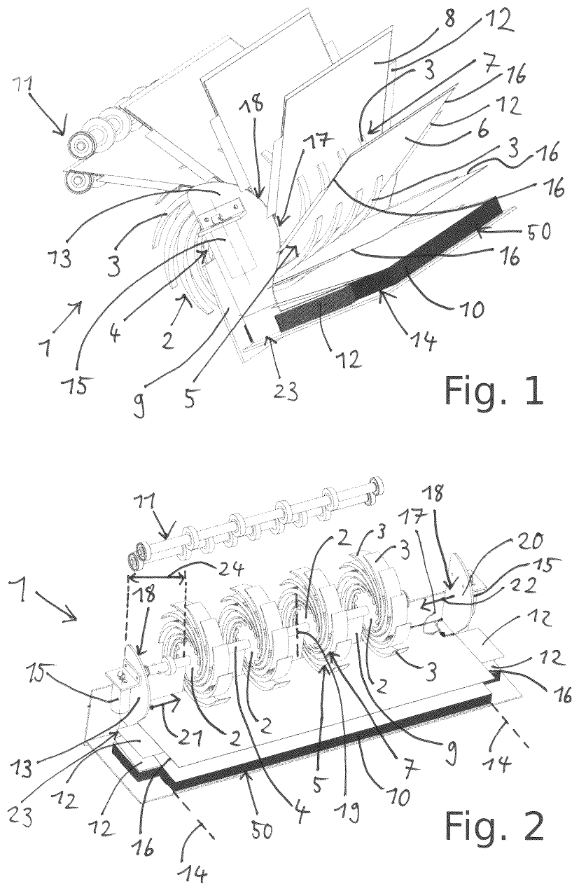

FIG. 1 shows a schematic representation of an exemplary embodiment of a stacking device according to the invention with a stacking wheel and a movable alignment element for aligning electrode elements to a lateral target position;

FIG. 2 shows a further schematic representation of the stacking device with the alignment element and a further alignment element, each having a curvature;

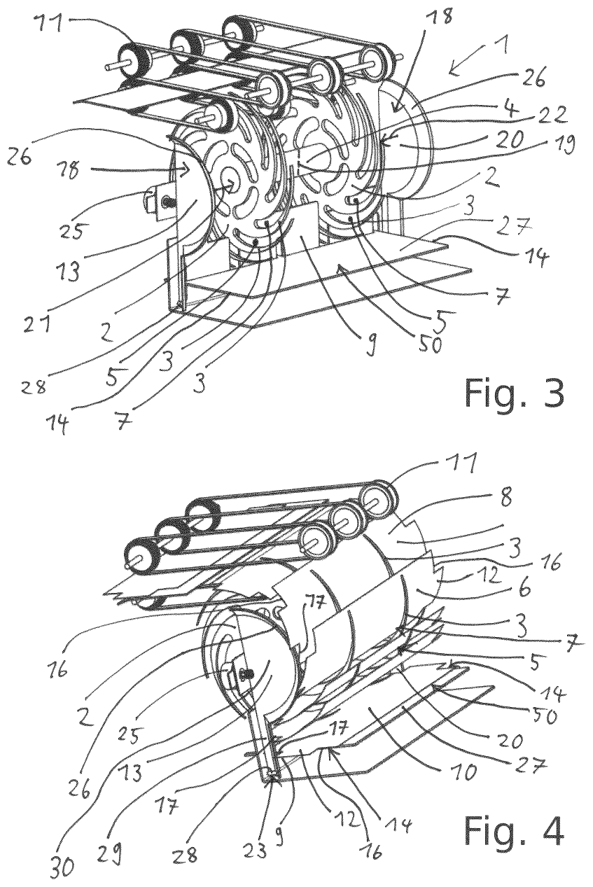

FIG. 3 shows a schematic representation of a further exemplary embodiment of the stacking device with the alignment elements and in each case a low-frequency drive unit;

FIG. 4 shows a schematic representation of a further exemplary embodiment of the stacking device with the alignment elements and the low-frequency drive units, during the production of an electrode stack;

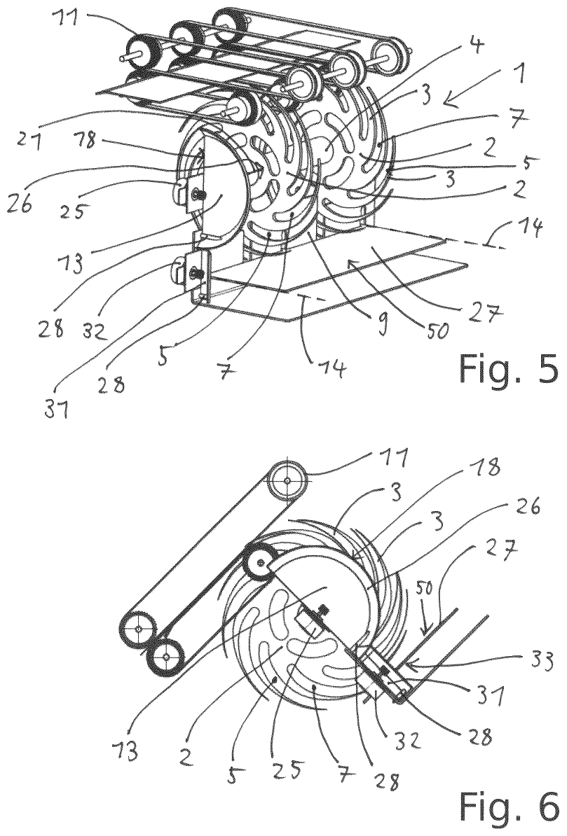

FIG. 5 shows a schematic representation of a further exemplary embodiment of the stacking device with an additional alignment element; and

FIG. 6 shows a schematic side view of a further exemplary embodiment of the stacking device with the additional alignment element and a stacking bottom in an oblique position.

In the figures, identical or functionally identical elements are provided with the same reference signs.

FIG. 1 and FIG. 2 schematically show an exemplary embodiment of a stacking device 1. The stacking device 1 has a stacking wheel 2 with multiple stacking fingers 3.

The stacking wheel 2 rotates about a rotation axis 4. In particular, the stacking wheel 2 rotates clockwise when viewed in the image plane of FIG. 1. The rotation speed is preferably specified at at least 20 revolutions per minute.

According to the exemplary embodiment, the stacking device 1 is formed with further stacking wheels 2, four in number according to FIG. 1 or FIG. 2. The further stacking wheels 2 are also arranged on the rotation axis 4.

The further stacking wheels 2 are preferably designed analogously to the stacking wheel 2. Below, the description is continued with reference to only one stacking wheel 2. The features of the one stacking wheel 2 also apply to the further stacking wheels 2.

According to the exemplary embodiment, the stacking fingers 3 are curved, in particular counterclockwise.

Furthermore, the thickness of the respective stacking finger 3 tapers with increasing distance from the rotation axis 4.

An intermediate space 5 is formed between the stacking fingers 3. The intermediate space 5 is designed to receive a flat first electrode element 6.

Furthermore, a further intermediate space 7 is formed between two, in particular adjacent, stacking fingers 3 of the intermediate space 5. The further intermediate space 7 is designed to receive a flat second electrode element 8.

The stacking fingers 3 are arranged distributed over the circumference of the stacking wheel 2.

The first electrode element 6 and/or the second electrode element 8 may, for example, be designed as a cathode, anode or separator or intermediate layer.

It may also be that the first electrode element 6 and/or the second electrode element 8 is designed as a combined element, for example as a combination of a cathode with a separator, an anode with a separator. Additionally or alternatively, it may also be that first electrode element 6 and/or the second electrode element 8 is designed as a cell which comprises a cathode, an anode and at least one separator.

The electrode elements 6, 7 or the first electrode element 6 and/or the second electrode element 8 are transported by the stacking wheel 2. The transport ends in particular in that the electrode elements 6, 7 are removed, preferably successively, from the stacking wheel, for example by means of a stripper element 9, and are deposited onto an electrode stack 10.

The electrode stack 10 we thus produced in particular by the electrode elements 6, 7 deposited or transported by the stacking wheel 2. Furthermore, the electrode stack 10 is produced in a stacking position 50.

Furthermore, the electrode elements 6, 7 are fed to the stacking device 1 in particular by means of a provision unit which is designed as a feeding device 11.

The first electrode element 6 and/or the second electrode element 8 can furthermore each also have at least one cell arrester 12. The cell arrester 12 is used for electrically conducting contacting. In contrast to what is shown in the figures, the cell arrester 12 may also be formed only on one side of the respective electrode element 6, 8.

The stacking device 1 also has an alignment element 13. The alignment element 13 is designed to be movable. The alignment element 13 moves the first electrode element 6 and/or the second electrode element 8 to a lateral target position 14.

The lateral target position 14 relates to the lateral alignment of the electrode elements 6, 8, i.e., the alignment axially with respect to the rotation axis 4.

By aligning the electrode elements 6, 8 to the lateral target position 14, the lateral stacking accuracy of the electrode stack 10 can be increased.

According to the exemplary embodiment, the alignment element 13 is designed to be active and is connected to a drive unit, in particular an unbalance drive unit 15. The unbalance drive unit 15 or the unbalance motor is designed to set the alignment element 13 in vibration. Preferably, the unbalance drive unit 15 vibrates the alignment element 13 at at least 20 Hz.

By means of the vibration, the electrode elements 6, 8 are moved to the lateral target position 14.

For the movement of the respective electrode element 6, 8, the alignment element 13 in the exemplary embodiment presses against a short side edge 16 of the respective electrode element 6, 8. Preferably, the pressing takes place at a high frequency and with multiple low-force contacts.

The alignment element 13 is preferably designed in such a way that the short side edge 16 of the respective electrode element 6, 8 is only contacted in a partial region 17 of the short side edge. The partial region 17 is in particular outside the region of the short edge in which the cell arrester 12 is formed. By restricting the alignment element 13 to the partial region 13, the respective electrode element 6, 8 can be contacted by the alignment element 13 without the cell arrester 12 being loaded.

In order to contact the respective electrode element 6, 8 only in the partial region 17, the alignment element 13 may, for example, be narrower than the entire short side edge or may have a recess.

According to the exemplary embodiment, the alignment element 13 has a curvature 18. The curvature 18 extends substantially in the rotation direction of the stacking wheel 2 or in the direction of a vertical axis 19 of the produced electrode stack. The curvature has the result that the lateral boundary, which is created by the alignment element, comes closer to the respective electrode element 6, 7 with continuing transport of the respective electrode element 6, 7. In other words, due to the curvature, the alignment element 13 is thus closer to a center 20 of the rotation axis 4 with continuing transport of the respective electrode element 6, 8. As a result, the respective electrode element 6, 8 is moved further and further in the direction of the lateral target position 14.

In particular, the stacking device 1 also has a further alignment element 20. According to the exemplary embodiment, the further alignment element 20 is designed like the alignment element 13 but is mirror-inverted. In particular, the further alignment element 20 is arranged axially on the other side of the stacking wheel 2 with respect to the rotation axis 4.

The alignment element 13 and the further alignment element 20 thus virtually form a half-funnel.

The further alignment element 20 may have a separate drive unit which is, for example, designed like the unbalance drive unit 15.

A direction of action 21 of the alignment element 13 and a further direction of action 22 of the further alignment element are thus respectively directed inward, i.e., to the center 19 of the rotation axis.

Furthermore, the alignment element 13 is preferably fastened on one side, i.e., only on a fastening side 23 of the alignment element 13. The fastening side 23 is in particular at a location where the alignment element 13 has the smallest deflection. Preferably, the fastening side 23 is thus as close as possible to the stripper element 9, the respective electrode element 6, 8 is preferably already in the lateral target position 14 during stripping, and a deflection or a great deflection of the alignment element 13 is therefore no longer necessary to align the respective electrode element 6, 8.

In particular, the alignment element 13 is arranged at a distance 24 from the stacking wheel 2 in the axial direction with respect to the rotation axis 4.

FIG. 3 and FIG. 4 schematically show a further exemplary embodiment of the stacking device 1. The stacking device 1 is designed analogously to the exemplary embodiment according to FIG. 1 and FIG. 2, but a low-frequency drive unit 25 is provided for driving or for moving the alignment element 13. The one low-frequency drive unit 25 preferably moves the alignment element 13 at a frequency of 0.5 Hz and 10 Hz in the direction of action 21 and back. As a result of the movement in the direction of action 21, the respective electrode element 6, 8 is contacted or pressed on the short side edge 16 by means of the alignment element 13, preferably until it is located in the lateral target position 14.

In addition, the alignment element 13 has a bevel 26 in the edge pointing radially away from the drive unit, in particular the low-frequency drive unit 25. As a result of the bevel 26, the respective electrode element 6, 8, in particular the respective cell arrester 12, can be treated more gently.

The stacking device 1 preferably also has a carried-along stacking bottom 27 onto which the respective electrode elements 6, 8 are deposited or stacked. According to the exemplary embodiment, the electrode stack 10 is produced on the stacking bottom.

The stacking bottom 27 is removed from the the rotation axis 4 in the radial direction with increasing electrode stack 10 so that further electrode element can be stacked. The carried-along stacking bottom 27 is advantageous since all electrode elements 6, 8 can be deposited from a low height onto the electrode stack 10 and are not thrown down from different heights. In particular, without the carried-along stacking bottom 27, the drop height or the depositing height for the electrode elements 6, 8 at the beginning of the stacking process would be high.

Additionally, the further alignment element 20 is also provided in particular. According to the exemplary embodiment, the further alignment element 20 is formed mirror-inverted to the alignment element 13.

Preferably, the two alignment elements 13, 20 move synchronously, i.e., simultaneously to the center 19 and back again. The respective electrode element 6, 8 is thereby simultaneously contacted on one side and on a side opposite the side. In other words, the respective electrode element 6, 8 is thus simultaneously contacted at both short side edges.

The further alignment element 20 is preferably moved by its own low-frequency drive unit 25, which cannot be seen in the figures.

If the electrode elements are arranged rotated about their vertical axis or their normal vector by 90°, as shown in the figures, in the stacking wheel 2, simultaneous contacting by the alignment elements 13, 20 takes place accordingly on the long sides of the electrode elements 6, 8.

Furthermore, the alignment element 13 according to the exemplary embodiment has a two-way bearing 28. The rotation axis of the bearing 28 is preferably formed rotated by 90° to the rotation axis 4.

Preferably, the alignment element 13 according to the exemplary embodiment is formed with a narrow web 29 and a wide main surface 30. The narrow web 29 connects the wide main surface 30 to the bearing 28. An advantage of the narrow web is that the respective cell arrester 12 is not or at least only slightly contacted and the alignment in the partial region 17 can nevertheless still be aligned on the electrode stack 10 or shortly before reaching the electrode stack 10.

FIG. 5 and FIG. 6 schematically show a further exemplary embodiment of the stacking device 1. The stacking device 1 is designed analogously to FIG. 3 and FIG. 4.

Additionally, the stacking device has an additional movable alignment element 31. The additional alignment element 31 is arranged on the same side of the stacking wheel 2 as the alignment element 13; the only difference is that the additional alignment element 31 is closer to the stacking bottom 27 than the alignment element 13. The additional alignment element preferably assumes the position of the narrow stay 29 of FIG. 3 and FIG. 4, while the alignment element 13 according to this exemplary embodiment only assumes the position of the wide main surface 30. This is advantageous since the alignment element 13 and the additional alignment element 31 can now be operated at a different frequency. Thus, the alignment element 13 can be operated, for example, at a low frequency, while the additional alignment element 31 is operated at a high frequency. The additional alignment element 31 can, for example, be operated via a high-frequency drive unit 32 at a corresponding frequency so that it vibrates.

Preferably, according to this exemplary embodiment, below the further alignment element 20, the stacking device 1 also has a further additional alignment element (not shown in the figures) which is mirror-inverted to the additional alignment element 31.

FIG. 6 shows the stacking device in a schematic side view. Furthermore, the stacking bottom 27 has an oblique position 33, the stacking bottom 27 is formed rotated counterclockwise in the image plane by approximately 40°. This is advantageous since a a passive longitudinal alignment of the electrode elements 6, 8 is carried out by gravity. According to the exemplary embodiment, in contrast to the lateral alignment, which relates in particular to a transverse alignment on the short side edge 16, the longitudinal alignment takes place on a long side edge of the respective electrode element 6, 8. The passive longitudinal alignment can be carried out without force, in particular without motor force or movable elements.

1.-15. (canceled)

16. A method for producing an electrode stack with flat electrode elements, in which the following steps are carried out:
a) providing a first electrode element;
b) inserting the first electrode element into an intermediate space which is formed by stacking fingers of at least one stacking wheel which rotates about a rotation axis;
c) transporting the first electrode element with the stacking wheel;
d) removing the first electrode element from the intermediate space;
e) arranging the first electrode element in a stacking position;
f) providing a second electrode element;
g) inserting the second electrode element into a further intermediate space which is different from the intermediate space and is formed by stacking fingers of the stacking wheel;
h) removing the second electrode element from the further intermediate space; and
i) arranging the second electrode element in the stacking position and producing the electrode stack,
wherein
at least the first electrode element is moved to a lateral target position by at least one movable alignment element.

17. The method according to claim 16, wherein the alignment element moves the second electrode element simultaneously with the first electrode element to the lateral target position.

18. The method according to claim 16, wherein at least the first electrode element is pressed to the lateral target position by the alignment element on an edge of the first electrode element extending radially to the rotation axis.

19. The method according to claim 16, wherein the movement of at least the first electrode element to the lateral target position is carried out while the first electrode element is transported in the intermediate space.

20. The method according to claim 16, wherein at least the first electrode element is additionally moved, in particular pressed, to the lateral target position by a further movable alignment element,
wherein the further alignment element acts against a direction of action of the alignment element.

21. The method according to claim 16, wherein the alignment element is moved axially to the rotation axis at a frequency between 0.5 Hz and 10 Hz.

22. The method according to claim 16, wherein the alignment element vibrates axially to the rotation axis at a frequency of more than 50 Hz.

23. The method according to claim 16, wherein the alignment element is moved by an unbalance drive unit.

24. The method according to claim 16, wherein at least the first electrode element is contacted by the alignment element only in a partial region of the edge of the first electrode element extending radially to the rotation axis.

25. A stacking device which is designed to produce an electrode stack with flat electrode elements, having:
a provision unit which is designed to provide an electrode element;
at least one stacking wheel having a rotation axis and multiple stacking fingers arranged radially to the rotation axis,
wherein the stacking fingers form multiple intermediate spaces which are each designed to receive an electrode element for transport; and
a stacking position which is designed for the arrangement of the electrode stack,
wherein the stacking device has a movable alignment element which is designed to move the electrode elements to a lateral target position.

26. The stacking device according to claim 25, wherein the alignment element is arranged at a distance from the stacking wheel in the axial direction with respect to the rotation axis.

27. The stacking device according to claim 25, wherein the alignment element is fastened only on a fastening side of the alignment element.

28. The stacking device according to claim 25, wherein the stacking device has a further movable alignment element which is arranged on the other side of the rotation axis with respect to a center of the rotation axis.

29. The stacking device according to claim 25, wherein the alignment element has a curvature extending in the direction of the rotation direction of the stacking wheel.

30. The stacking device according to claim 25, wherein the stacking device has an additional movable alignment element which is arranged after the alignment element with respect to a rotation direction of the stacking wheel.
